(19) United States
(12) Patent Application Publication
(10) Pub. No.: US 2003/0200210 A1
(43) Pub. Date: Oct. 23, 2003

(54) Method of searching an email address by means of a numerical code including a combination of specific phone numbers

(76) Inventor: Chung Yu Lin, Kaohsiung (TW)

Correspondence Address: Raymond Y. Chan, Suite 128, 108 N. Ynez Avenue, Monterey, CA, 91754, US

(21) Appl. No.: 10/328,607

(22) Filed: Dec. 23, 2002

Related U.S. Application Data
(60) Provisional application No. 60/374,559, filed on Apr. 23, 2002.

(51) Int. Cl. G06F 17/30

(52) U.S. Cl. 707/4

(57) ABSTRACT

An email address searching method includes the steps of providing an information database, wherein a plurality of email addresses stored in said information database are respectively assigned with specific numerical phone codes each of which is a combination of predetermined phone numbers of a register of said respective email address; receiving a search request from an email sender by inputting a combination of phone numbers as a search code for an email to be sent by said email sender; and matching the search code with the phone codes to search for the respective phone code that matches identically with the search code so as to search out the corresponding email address assigned with the respective phone code efficiently and promptly.

### CROSS REFERENCE OF RELATED APPLICATION

This is a regular application of a provisional application, application No. 60/347,559, filed on Jan. 9, 2002.

### BACKGROUND OF THE PRESENT INVENTION

1. Field of Invention

The present invention relates to a searching method, and more particularly to a method of searching a specific email by means of a numerical code including a combination of a plurality of specific phone numbers, thus avoiding a user to memorize lengthy and sometimes irrational email addresses.

2. Description of Related Arts

After years of information technological advancement, it is indisputably to claim that people nowadays have heavily and necessarily depended on some sorts of digital or electronic information exchange channels such as the Internet. With this ever-dependence on information technology, people are finding more convenient and faster ways of broadcasting and exchanging information in order to promote growth and increase competitive edge for their respective own industry or just simply increase the living standard of them.

One popular method of rapidly and precisely transferring information is by means of emails. Email systems utilize the Internet or World Wide Web (www) as a medium to transfer individual emails from the senders to the respective recipients. More explicitly, when a user want to transfer information, in the forms of written texts or computer files, to a particular recipient, the user only needs to prepare an email, by using some form of email software or otherwise, and then upload it to a mail server connected to the Internet. The recipient will then receive some sort of notification when connected to the Internet and open a certain mail receiving software. In order to receive the email, the recipient needs only to download the specific email from that mail server to complete the email transferring process. Then, the recipient can be able to obtain the information as sent from the email sender. One advantage of such email system is that the sender and the recipient need not be connected to the Internet at the same time in order to complete the email transferring process. One can put an email in the mail server for a specified period of time.

Currently, there are two main categories of email systems, namely the Post Office Protocol (POP) email system and the Web-Based email system. For the POP email system, as shown in FIG. 1, a particular email software must be installed to the senders' and recipients' computers. Under the POP email system, the sender (S) needs first to draft an email and upload it to a Simple Mail Transfer Protocol (SMTP) server (1) through the Internet (I), the email is then transferred to the recipient's POP server (2), wherein when the recipient (R) accesses to the Internet (I), he/she can download the email from the POP server (2) to his/her computer to complete the email transferring process.

On the other hand, under the Web-Based email system, as shown in FIG. 2, the sending and the retrieval of a particular email are completely through the World Wide Web (W). Accordingly, instead of email software, the sender (S) and the recipient (R) each needs a browser which is capable of surfing web pages through the World Wide Web (W), wherein the email is first uploaded to a web server (3) by the sender (S) and then downloaded to the recipient (R). The main advantage of this method is that the sender and the recipient can send and receive an email at any computer which is connected to the Internet. No additional email software is required.

Each of the emails is characterized by a unique email address which is made up by characters, such as alphabets, numbers and punctuations, wherein all correspondence concerning a particular email is referred to its email address. As a matter of fact, with the ever-growing usage of information technology, there are tremendous but yet still increasing numbers of email addresses registered all over the world. Currently, there are over twenty millions established websites which can be accessed through World Wide Web all around the world, wherein the host of most of those websites could have one or more email addresses shown to their browsers for contact or information exchange purposes. Thus, there exists a huge amount of email addresses registered with different mail servers all around the world. In practices, there are a numbers of Internet Service Providers which provide email service to individuals or companies.

Despite all advantages, one of the pressing problems associated with emails are with the email addresses. Currently, a particular email address is usually determined by the user of that email account. Given the tremendous number of email users, plus the unique nature of each of the email addresses, popular email addresses run out quickly for a particular mail server, i.e. they are soon registered or ‘occupied’ by users. Therefore, for those who cannot obtain an indicative or simple email address, they have no choice but to amend their desirable email addresses to a longer, more complicated address. For some popular mail servers, such as ‘Yahoo’ or ‘Hotmail’, the ‘competitions’ are indeed extremely keen.

In addition, currently there is no authoritative agent and centralized mechanism to govern the distribution and allocation of email addresses. As a result, a particular email address can take any form made up from a plurality of characters, such as alphabets and numbers. Very often, an email address is totally irrational and possesses no indicative meaning at all to its owner.

Due to the above-mentioned reasons, one can easily have a hard time remembering email addresses. Some people, when they forget, try to guess the email address from a company name (e.g. IBM, SONY etc.) which he/she wants to contact. However, such strategy is somewhat ineffective even for famous organizations. Thus, the best way to remember an email address is to record it.

However, recordation by itself is not panacea, for there still are limitations due to the following reasons:

(a) Occasionally, if one is traveling or going for business trips, he/she may not have the opportunity to use the computer that he/she usually uses. Furthermore, he/she may not be able to access to his/her recordation for certain reasons. As a result, some desirable or necessary email addresses may not come with him/her. Then, when the user want to contact the host of those email addresses, he/she has to either search again or call for help from his/her home or company. Even the user is able to call for help, say by telephone, pronunciation similarity of the characters of the email addresses may cause significant confusion. For example, one is difficult to distinguish ‘b’ and ‘d’ in telephone conversation. Therefore, the user may incorrectly regard ‘b’ as ‘d’, or vice versa. Even if the user can finally call for help, say by telephone, during the process of searching the email addresses, the user may have already wasted valuable business time. If the user is in a region in which its time zone is different from his/her company's time zone, the searching time may be even further unnecessarily prolonged.

(b) In this information era where e-commerce dominates, especially for such developed countries as the United States of America, email communication cannot be avoided. For some corporations, email communication is often the main communication method between departmental staff, or between the company and its customers. In these cases, a large amount of email addresses is involved. The question as to how to handle this large amount of irrational email addresses possesses great challenge to company's managerial level.

In light of the above, a more systematic approach of handling tremendous email addresses may be used.

### SUMMARY OF THE PRESENT INVENTION

A main object of the present invention is to provide a method of searching an email address by means of a unique numerical code including a combination of predetermined phone numbers, wherein the particular email address, and its corresponding numerical code are registered together in a server, such that when a user wants to send an email to that specific email address, he/she can just provide the numerical code corresponding to that email address to the server, without needing to deal with the actual email address.

Another object of the present invention is to provide a method of searching an email address by means of a unique numerical code including a combination of predetermined phone numbers, wherein the unique numerical code and its corresponding actual email address are registered together in a server to act as a unique identifier of an email account.

Another object of the present invention is to provide a method of searching an email address by means of a unique numerical code including a combination of predetermined phone numbers, wherein more than one numerical codes are allowed to register with a server to act as unique identifiers of that specific email, so that a user can be able to send information to that particular email by specifying any one of the numerical codes associated with that email.

Another object of the present invention is to provide a method of searching an email address by means of a unique numerical code including a combination of predetermined phone numbers, wherein relatively lengthy and complicated email addresses are organized by their corresponding numerical codes, so that senders can be able to retrieve a desired email address quickly and easily by using the respective numerical code. In other words, the time associated with searching and retrieving conventional lengthy and complicated email addresses are minimized.

Another object of the present invention is to provide a method of searching an email address by means of a unique numerical code including a combination of predetermined phone numbers, wherein the phone numbers are registered with the email holder's local telecommunication networks and are publicly available in telephone directories, so as to minimize the difficulty and problems arose in retrieving the required phone numbers, i.e. the numerical codes, such as calling back to home country by a user while he/she is traveling.

In order to accomplish the above objects, the present invention provides an email address searching method, comprising the steps of:

(a) providing an information database, wherein a plurality of email addresses stored in said information database are respectively assigned with specific numerical phone codes each of which is a combination of predetermined phone numbers of a register of said respective email address;

(b) receiving a search request from an email sender by inputting a combination of phone numbers as a search code for an email to be sent by said email sender; and

(c) matching the search code with the phone codes to search for the respective phone code that matches identically with the search code so as to search out the corresponding email address assigned with the respective phone code.

The email address searching method of the present invention further comprises, after the step (c), a step (d-1) of, when the respective phone code is found, sending the email to the email address assigned with the phone code matched with the search code.

The email address searching method of the present invention further comprises, after the step (c), a step (d-2) of, when none of the phone codes is matched with the search code, requesting the email sender to re-input another search code.

According to the email address searching method of the present invention, the combination of phone numbers of each of the search code and the phone codes includes a registered phone number of the register of the respective email address, wherein the registered phone number comprises a country code number, an area code number, and a local phone number.

### BRIEF DESCRIPTION OF THE DRAWINGS

FIG. 1 is a block diagram of a conventional POP email system.

FIG. 2 is a block diagram of a conventional Web-Based email system.

FIG. 3 is a block diagram illustrating a method of searching a specific email address by means of a unique numerical code including a combination of specific phone numbers according to a first preferred embodiment of the present invention.

FIG. 4 is a flow chart of the Visual Basic Script of the search request web page according to the above first preferred embodiment of the present invention.

FIG. 5 is a flow chart of the Visual Basic Script of the searching process according to the above preferred first embodiment of the present invention.

FIG. 6 is a block diagram illustrating an alternative mode of the email address searching method according to the above first preferred embodiment of the present invention.

FIG. 7 is a block diagram illustrating a method of searching a specific email address by means of a unique numerical code including a combination of specific phone numbers according to a second preferred embodiment of the present invention.

FIG. 8 is a block diagram illustrating an alternative mode of the method of searching a specific email address by means of a unique numerical code including a combination of specific phone numbers according to the above second preferred embodiment of the present invention.

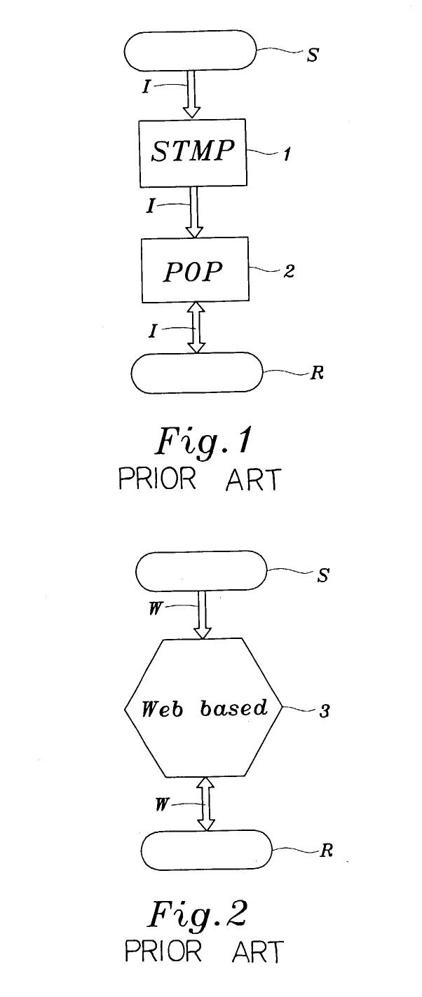

### DETAILED DESCRIPTION OF THE PREFERRED EMBODIMENT

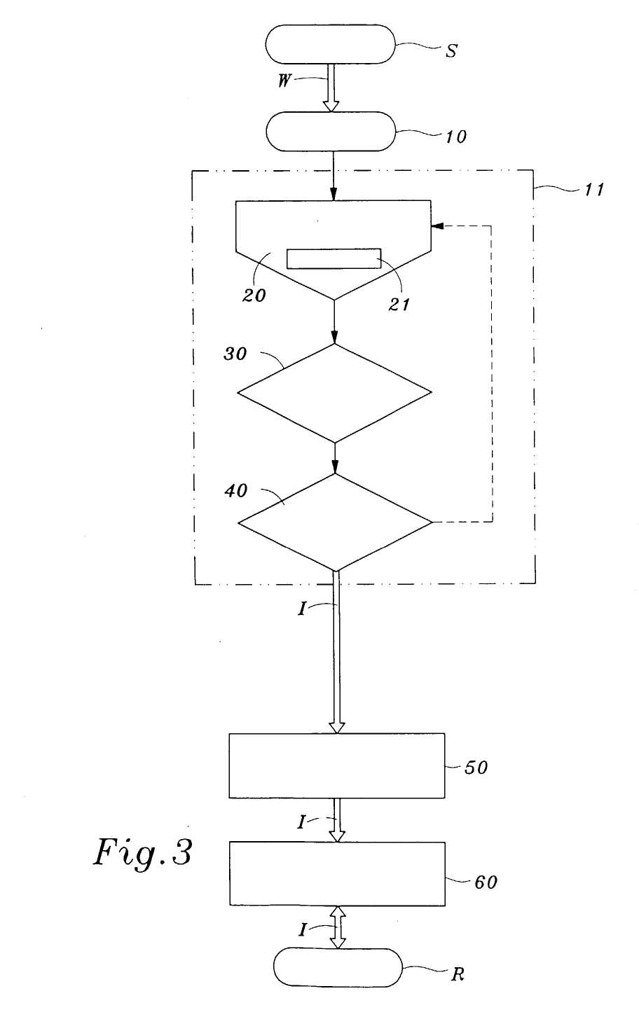

Referring to FIGS. 3 to 8 of the drawings, a method of searching an email address by means of a unique numerical code including a combination of specific phone numbers according to a first preferred embodiment of the present invention is illustrated, wherein the email address searching method comprises the steps of:

(a) providing an information database 40, wherein a plurality of email identifiers stored in said information database 40 are respectively assigned with specific numerical phone codes each of which includes a combination of predetermined phone numbers of a register of said respective email address;

(b) receiving a search request from an user, such as an email sender S, by inputting a combination of phone numbers as a search code for an email to be sent by said email sender S; and

(c) matching the search code with the phone codes to search for the respective phone code in the information database 40 that matches identically with the search code so as to search out the corresponding email identifier assigned with the respective phone code.

According to the email address searching method of the present invention, the combination of phone numbers of each of the search code and the phone codes includes a registered phone number of the register of the respective email address, wherein the registered phone number comprises a country code number, an area code number, and a local phone number.

According to the first preferred embodiment of the present invention, the information database 40 is linked with an information center which is arranged to be connected to the Internet. In the step (b), the search request sent from the email sender (S) is received by the information center, wherein the search request is sent along with an email sending request from the email sender (S) and the email sending request includes the search code.

According to the first preferred embodiment, the email address searching method of the present invention is primarily used through the email processing website of the Internet, and is intended to work with a POP email system. The information center is pre-loaded into a computer system, which is connected with a plurality of computer systems through the Internet. Accordingly, the information center is linked to the World Wide Web (WWW) wherein any computer system linked to the World Wide Web can also connect to the information center.

The information center comprises an email processing website 10 which comprises a particular website server 11 connected to the World Wide Web (W), wherein the email processing website 10 comprises a search request web page 20. The search request web page 20 can be a home page of that email processing website 10, or it can be one of the web pages under the email processing website 10.

Since the information center is connected to the World Wide Web through Internet, thus any other computer systems that are also connected to the World Wide Web can access to the information database by connecting to the email processing website 10. Accordingly, the search request web page 20 is designed and programmed by any one of software which supports World Wide Web application, such as XHTML, HTML, XML, PHP, ASP, CSS, JSP, C, C++, CG120, Java, Java-script, ActiveX, and etc. through high level language such as Visual Basic Script.

The information database 40 is provided in the website server 11 and stores email identifiers and their corresponding phone codes. The email identifiers can be the conventional identification of a particular email account, such as an email address.

According to the first preferred embodiment of the present invention, for each of the email address stored, a unique phone code is assigned to a corresponding email identifier so that each email account is not only characterized by its email address, but also by a unique phone code corresponding to that email address.

Each of the phone codes consists of a combination of phone numbers in a sequence of:

Country Code−Area Code−Local Phone Number

wherein the local phone number is the local phone number of the corresponding email address register, the area code is the official telephone area code number of that email address register, and the country code is the international telephone country code number of that email address register. Depending on the nature of the email address registers, the email address register can be a corporation, an institution, or a company. Nevertheless, each of them should have a local contact telephone number. It is worth to stress that the uniqueness of each phone code can be ensured by combining the local phone number with the area code and the country code in which the corresponding email address register is assigned by local telecommunication authority.

For example, if a register of an email address, chungyulin@lins.com, has a registered local phone number “5719812” in Los Angeles which has an area code “626” in the United States which has a country code “1”, the corresponding phone code of the email address of the register, chungyulin@lins.com, is “16265719812”.

Given the function of the above-mentioned search request web page 20, the search request web page 20 preferably contains at least a section that allows the user of this searching method to input a numerical search code which is known to the email sender (S). The numerical search code is the phone code of the email account that the email sender (S) intents to reach. In other words, the numerical search code must also be inputted in the sequential format of:

Country Code−Area Code−Local Phone Number.

Thus, the email sender (S) is required to enter the corresponding numerical phone code in order to search for the email address that he/she wants to reach. According to the first preferred embodiment, in the step (c), the search code is searched from the information database 40 by matching the search code with the phone codes stored in the information database 40 to achieve a search result which includes a respective email address of the recipient (R) of the email to be sent.

For example, if the email sender wants to send an email to the register of the email address chungyulin@lins.com, however the email sender forgets such email address or not sure whether the email address should be chunglin@lins.com, chungyulin@lin.com or others while the email sender remembers the phone number of the recipient, i.e. the register of the phone number and email address, the email sender can still send the email to the recipient by inputting a search code consisting of the combination of the country code number, area code number and the local phone number of the recipient, i.e. the “16265719812”. Since such phone number, country code+area code+local phone number, is a unique number of the register that would absolutely not identical with any other phone number, the search code can match the phone code “16265719812” assigned for the designated chungyulin@lins.com. So that the email can be sent to the correct email address without remembering what is it.

According to the present invention, when none of the phone codes is matched with the search code, the email address searching method of the present invention further comprises, after the step (c), a step (d-2) of requesting the email sender to re-input another search code.

To the email sender (S), when the respective phone code is found, the email address searching method of the present invention further comprises, after the step (c), a step (d-1) of sending the email to the email address assigned with the phone code matched with the search code.

The searching process in the step (c) is carried out by comparing the entered numerical search code with each of the stored phone codes which represent individual email addresses respectively. If the numerical search code matches one of the stored phone codes, a search result which contains the email address assigned with that phone code is achieved. Then, the found email address plus the email sender's email will be sent to his/her SMTP email server 50 which in turns send the email to the recipient's (R) POP email server 60 through the Internet (I). Then, the recipient (R) can retrieve the email from the email sender (S) by downloading the email from his/her POP email server 60 through the Internet (I).

However, in the step (d-2), if the numerical search code does not match with any of the phone codes stored in the information database 40, a re-enter web page will be immediately prompted to allow the user to re-enter a new numerical search code or amend the pervious unmatched search code. Of course, the email prepared by the email sender (S) will not be sent to any recipient.

It is worth to mention that the email address searching method of the present invention is not limited to single numerical code searching. Thus, for each of the email identifier stored in the database 40, it can be assigned with more than one phone codes. When the numerical search code matches with any one of the phone codes assigned for such particular email address, the email will be sent to that particular email address, following the procedures as stated above. Furthermore, the local phone number is not limited to personal phone number. It can be a company's contact number, or the mobile phone number of the email account's owner.

Also, when the register assigns one or more phone codes to his/her registered email address, the information center will proceed a code search to determine whether the inputted phone code has been assigned to any other email address yet, otherwise children or the spouse may use the same phone number to their own registered email address.

When the email address register assigns phone code to his/her registered email address, the information center may request the email address register to verify that the email address register must be the owner of such elected phone number to prevent one's own phone number from being occupied by another.

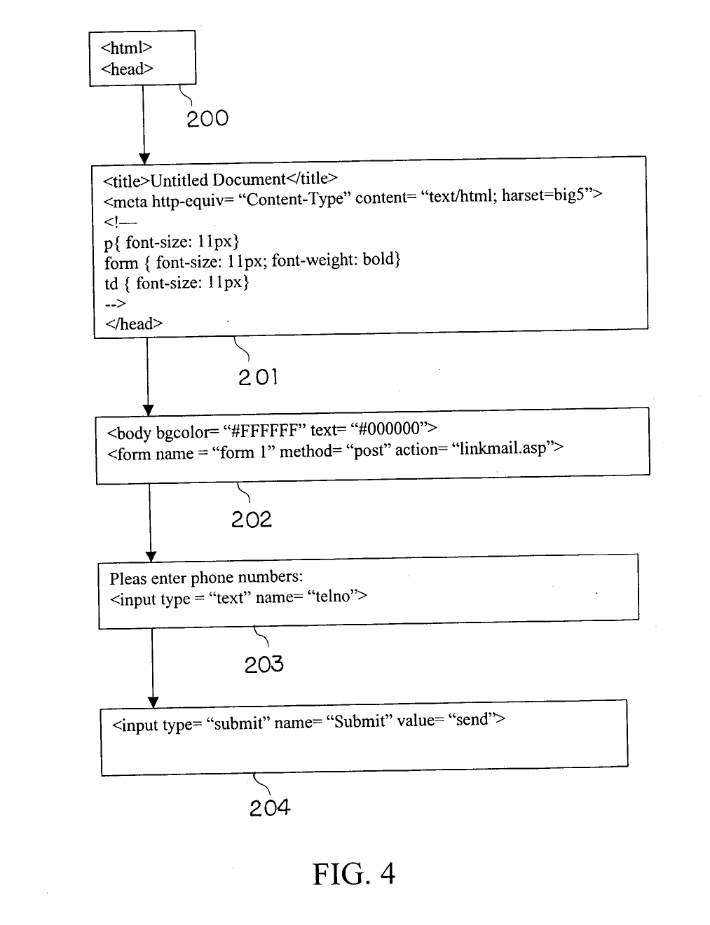

As illustrating in FIG. 4, for the first preferred embodiment of the present invention, the sequential executions of the search interface dynamic web page programs 200, 201, 202, 203, 204 of the search request web page 20 are illustrated as follows:

Program 200: Set the language of the search request web page 20 to be used, which is the same as that of the website browser.

Program 201: Enable Hypertext for the search request web page 20 in the Internet.

Program 202: Set the format of all the fonts and forms shown in the search request web page 20.

Program 203: Allocate a specific c ode location 21 in the search request web page 20 that allows the browser of the search request web page 20 to enter the numerical search code of the email address that he/she wants to reach.

Program 204: After complete the program 202, execute the searching process.

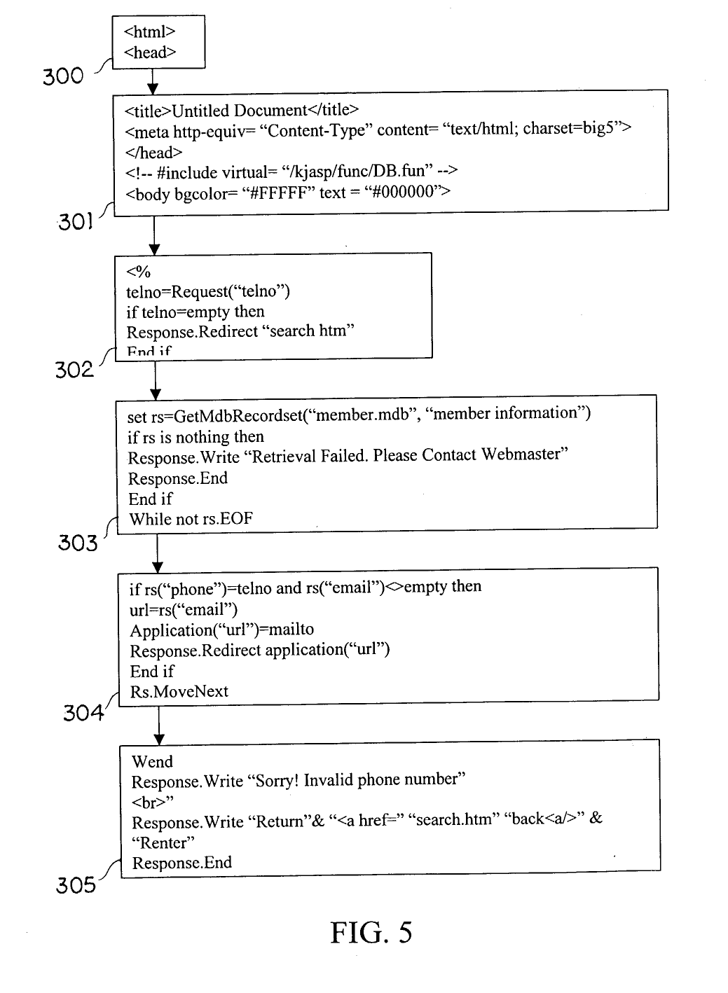

As shown in FIG. 5, for the first preferred embodiment of the present invention, the sequential executions of the programs 300, 301, 302, 303, 304, and 305 of the search program 30 are illustrated as follows:

Program 300: Setting the language or the communication medium of the searching process, which should be identical to that of the website browser.

Program 301: Enabling Hypertext of the searching process in the Internet.

Program 302: Checking the validity of the inputted numerical search code; i.e. to check whether the imputed numerical search code is recognizable by the searching program or not, such as whether there is space remained unfilled in the code location 21 in the search request web page 20, so as to ensure adequate recognized information is inputted to execute the searching process.

Program 303: Contacting the information database 40.

Program 304: Executing the step (c), that is to match the search code with the phone codes to search for the respective phone code in the information database 40 that matches identically with the search code so as to search out the corresponding email identifier assigned with the respective phone code. If the corresponding phone code that matches with the search code is found, launch the mail software and proceed the connection with the SMTP email server of the corresponding email address assigned with the found phone code. If no phone code matches the search code, proceed the next program.

Program 305: Receiving the signal from Program 304 that there is no phone code matching with the search code, immediately transfer a message to the email sender for requesting to reenter another search code in the code location 21 in the search request web page 20.

Referring to FIGS. 3, 4 and 5, when an email sender (S) completes an email and enters the particular website 10 by connecting to the World Wide Web (W) via a wire transmission, such as local phone lines, TV cables, and etc., or wireless transmission, such as cellular phone, PDA, satellite phone, and etc., the email sender (S) may click into the search request web page 20 and then input the search code in the code location 21 in the search request web page 20, wherein the search code includes a combination of specific phone numbers owned by the designated recipient (R) of the email to be sent, wherein the combination of specific phone numbers, in sequential order, consists of the country code+area code+local phone number which can be a personal telephone number or a corporate telephone number of the recipient (R). For example: 1 (America)−626 (Los Angeles)−1234567 (local phone number).

The local phone number can be a cellular phone number. For some countries, such as Taiwan, there is no area code for cellular phone number. For example, when using Taiwan cellular number as the phone code or search code, the country code number for Taiwan is “886” and the cellular phone number is “912−345−678”. Therefore, the phone code of the email address should be “886912345678” and the search code to be inputted to search for such email address by means of the corresponding phone code must be “886912345678” too. Accordingly, a cellular phone can be used to input the search code where the code location is displayed on a screen of the cellular phone that connects to the Internet via a wireless communication network.

After key in the search code “country code number−area code number−local phone number” in the code location 21 of the search request web page 20, wherein if there is no area code number, then no area code number is needed to key in and simply key in the country code number and the local phone number, the web page programs 200, 201, 202, 203, and 204, as shown in FIG. 4, will execute their program commands in sequence and then immediately execute the comparison of the search code with the phone codes and their corresponding email addresses stored in the information database 40 through executing the program commands of the programs 300, 301, 302, 303, and 304 of the search program 30. When any one of the phone codes stored in the information database 40 is found that identically matches with the search code inputted in the code location 21 of the search request web page 20, immediately transmit the specific email address assigned with said found phone code to the SMTP email server 50 of the email sender (S) through the Internet (I) and send the email sender's (S) email via the SMTP email server 50 to the POP email server 60 of the recipient (R) through the Internet (I). Accordingly, the recipient (R) can download and access the email from the email sender (S) from his/her POP email server 60.

Also, when there is no phone code in the information database 40 found matching with the search code after execution of the programs 300, 301, 302, 303, and 304 of the search program 30, the program 305 immediately send a command such as “Please Re-Enter A Correct Phone Number Combination” in the search request web page 20 to inform the email sender (S), wherein the email sender (S) must enter another correct phone number combination in order to proceed another comparison search.

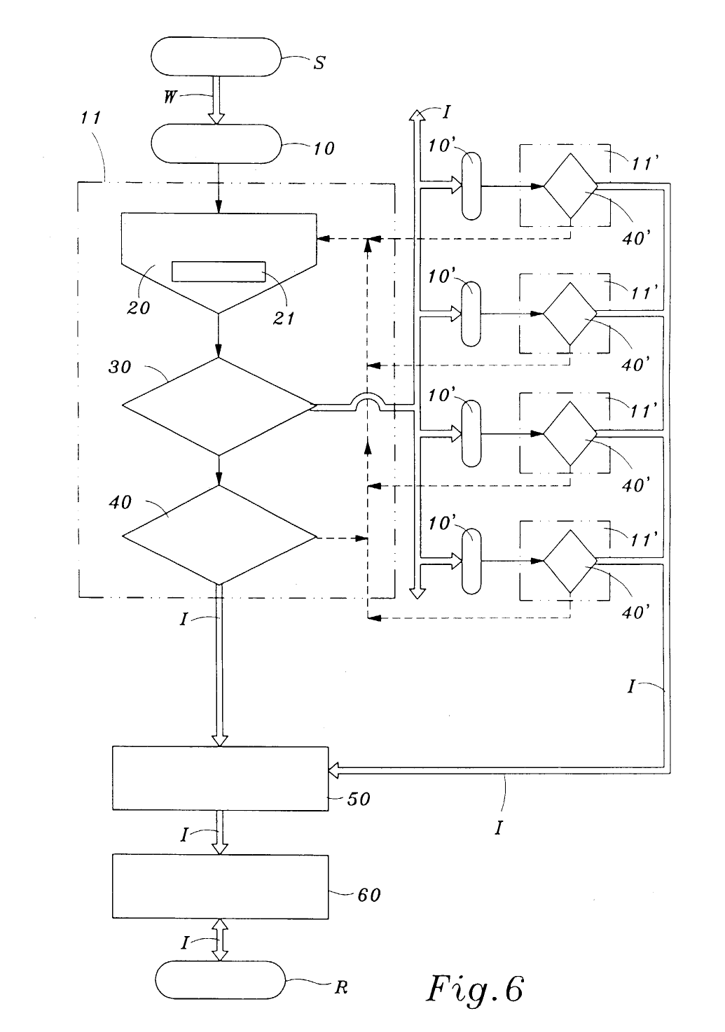

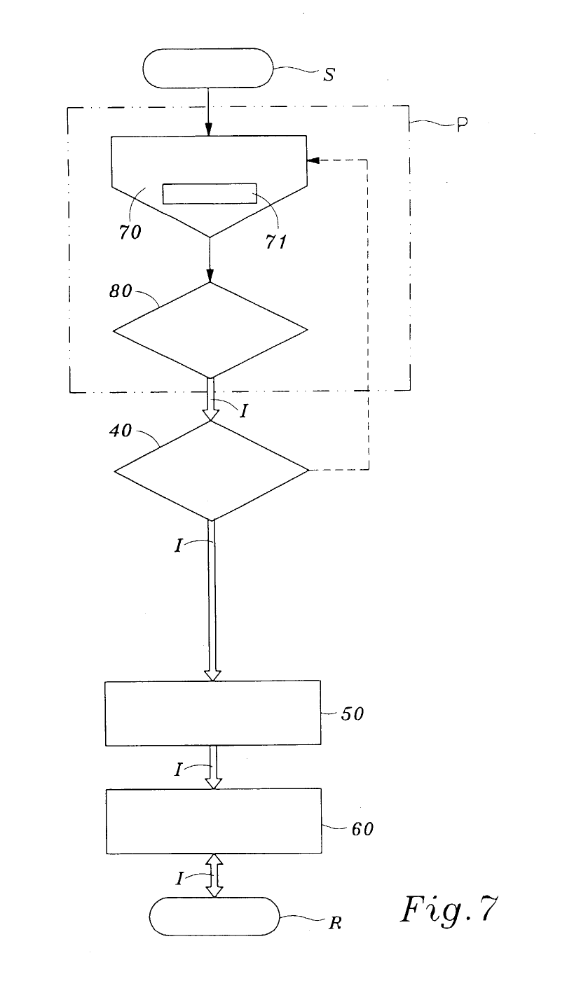

Referring to FIG. 6 of the drawings, an alternative mode of the email address searching method according to the above first preferred embodiment of the present invention is illustrated, wherein the search website 10′ is linked to a plurality of website servers 11′, wherein each of the website servers comprises an information database 40′ which stores a plurality of email identifiers such as email addresses and their phone codes respectively. In other words, the information database 40′ of the search website 10′ is significantly expanded.

Accordingly, the step (c) the email address searching method according to the alternative mode of the first preferred embodiment further comprises the steps of:

(c-1) searching the numerical search code from the plurality of information databases simultaneously; and

(c-2) matching the search code with the phone codes stored in the information databases to search for the respective phone code that matches identically with the search code so as to search out the corresponding email identifier, such as the email address, assigned with the respective phone code.

In the first alternative mode, the searching process is carried out by comparing the entered numerical search code with each of the stored phone codes which represents a unique website from the plurality of information databases 40′. If the numerical search code matches one of the stored phone codes, a search result which contains the designated email address represented by that phone code will be achieved. Then, the email prepared by the user, such as the email sender (S), will be automatically sent to the SMTP email server 50′ of the user wherein the email will be finally sent to the recipient's (R) POP server 60′ under the designated email address.

However, if the numerical search code doesn't match with all the stored phone codes in the information databases 40′, a web page will be automatically opened which allows the email sender (S) to enter another numerical search code, and preferably, informs the email sender (S) that the previous search turns out to be no matched email address in the information databases 40′. Of course, the above communication processes are, as usual, embodied to be accomplished by means of the Internet.

Referring to FIG. 7 of the drawings, an email address searching method according to the a second preferred embodiment of the present invention is illustrated, wherein the second preferred embodiment is pretty much the same as the above first preferred embodiment, except the information center introduced in step (a), and that the searching method operates in a pre-loaded email processing software rather than an email processing website. According to the second preferred embodiment, an email processing software 70 is pre-loaded into the user's computer system (P) which is connected to a particular server through the Internet, wherein the email processing software 70 comprises a search request interface providing a code location 71 which contains a section to allow the user such as an email sender (S) to input the numerical search code to the email processing software 70 and to execute the searching and matching process in the step (c). The information database 40, which stores the email identifiers such as email addresses and their corresponding phone codes, is provided in a server connected with the Internet, that the user's computer system connects thereto.

Similar to the first preferred embodiment, the searching process according to the second preferred embodiment of the present invention is carried out by comparing the entered numerical search code with each of the phone codes stored in the information database 40 of the server through the Internet and each represents an individual email address. If the inputted numerical phone code matches one of the stored phone codes, a search result which contains the designated email address represented by that phone code is achieved. Then, the designated email address plus the email sender's (S) email will be sent to the recipient's (R) SMTP email server 50 which in turns send the email to the recipient's (R) POP email server 60 through the Internet. Afterward, the recipient (R) can retrieve the email from the email sender (S) by downloading the email from his/her POP email server 60 through the Internet.

For example, as shown in FIG. 7, when an email sender (S) selects to send an email through the second preferred embodiment of the present invention, the email sender (S) can open the email processing software 70 in his/her computer and enters a combination of specific phone numbers as a search code, “country code number+area code number+local phone number”.

For example:

(a) 1 (country code of the United States)−626 (area code of Los Angeles)−1234567 (local phone number of the recipient (R)), so that the search code is “16261234567”; or

(b) 886 (country code of Taiwan)−912-345-678 (cellular phone number of the recipient (R) in Taiwan), so that the search code is “886912345678”.

When the email sender (S) completes an email and enters the search code in a code location 71 of the email processing software 70 of the user's computer system (P) which is connected to the information database 40 in the server through the Internet by means of a wire transmission, such as local phone lines, TV cables, and etc., or wireless transmission, such as cellular phone, PDA, satellite phone, and etc., a search program 80 installed in the user's computer system (P) is activated to proceed a comparison search to match the search code with all the phone codes stored in the information database 40, wherein each of the phone codes is an unique numerical code consists of a combination of specific phone numbers owned by the register of the corresponding email address, same as the first preferred embodiment, wherein the combination of specific phone numbers, in sequential order, consists of the country code+area code+local phone number which can be a personal telephone number or a corporate telephone number of the recipient (R), i.e. the register of the respective email address.

When any one of the phone codes stored in the information database 40 is found that identically matches with the search code inputted in the code location 71 of the email processing software 70, immediately send the email sender's (S) email to the SMTP email server 50 through the Internet (I), and then the SMTP email server 50 will send the email to the POP email server 60 of the recipient (R) through the Internet (I). Accordingly, the recipient (R) can download and access the email from the email sender (S) from his/her POP email server 60.

Also, when there is no phone code in the information database 40 found matching with the search code, the email prepared by the email sender (S) will not be sent to any recipient (R). Then, the search program 80 immediately sends a command such as “Please Re-Enter A Correct Phone Number Combination” to the email processing software 70 to inform the email sender (S), wherein the email sender (S) must enter another correct phone number combination in the code location 71 in order to proceed another comparison search.

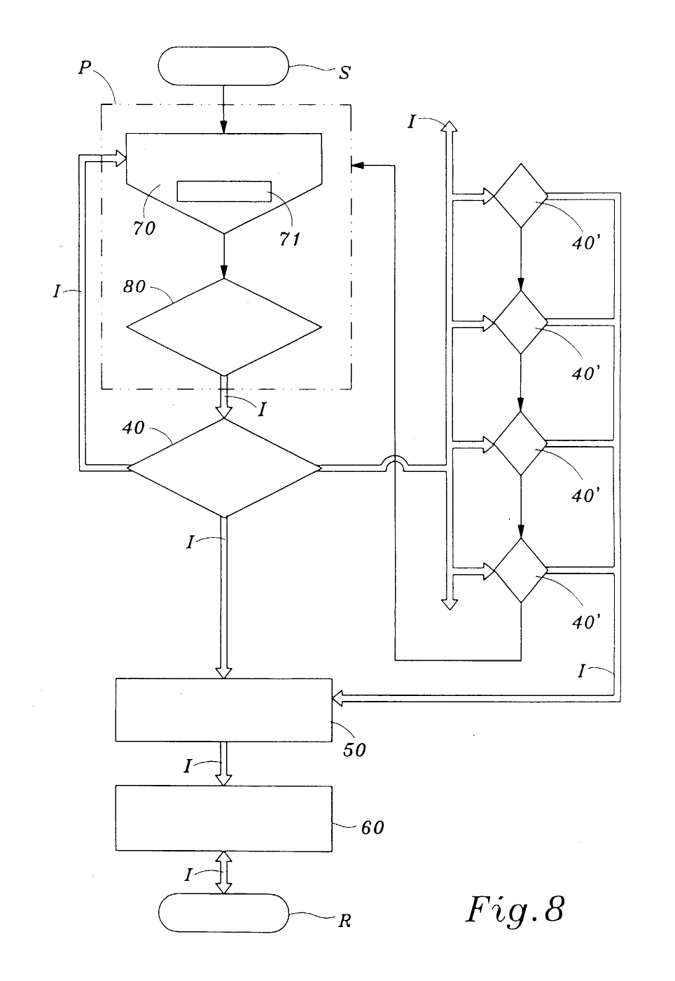

As a slight modification to the above second preferred embodiment of the present invention, an alternative mode is illustrated in FIG. 8 of the drawings, wherein the searching process is carried out by comparing the entered numerical search code with each of the phone codes stored in a plurality of information database 40′ in different servers of the Internet. If the numerical search code matches anyone of the stored phone codes in any of the information databases 40′, a search result which contains the designated email address assigned with said matched phone code will be achieved. Then, the email prepared by the email sender (S) will be automatically sent to the SMTP email server 50 of the email sender (S), wherein the email will be finally sent to the recipient's (R) POP email server 60 of the recipient's (R) email address. It is worth to mention that the email transferring system in the alterative mode of the second embodiment is POP email system, i.e. using an email processing software 70 as a computer-user interface rather than a web page.

If the numerical search code doesn't match with all the stored phone codes in any of the information databases 40′, a command will be sent to the email processing software 70 to request the email sender (S) to enter another numerical search code, and preferably, informs the email sender (S) that the previous search turns out to be no matched email address in the information databases 40′. Of course, the above communication processes are, as usual, accomplished through the Internet.

From the forging description, the present invention provides a method of searching an email address by using a unique phone code of that email account, therefore reducing the troublesome and problems arising from searching or accessing lengthy email addresses. Accordingly, one skilled in the art will understand that the embodiment of the present invention as shown in the drawings and described above is exemplary only and not intended to be limiting.

It will thus be seen that the objects of the present invention have been fully and effectively accomplished. The all embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A method of searching an email address of a Web-Based type email system, comprising the steps of:
(a) providing at least an information database in a website server connected to an Internet, wherein said website server comprises a search program and a search request web page having a code location, wherein a plurality of email addresses stored in said information database are respectively assigned with specific numerical phone codes each of which includes a sequential combination of a country code number, an area code number and a local phone number of a register of said respective email address;
(b) receiving a search request from an email sender by inputting a numerical search code in said code location of said website server for an email to be sent by said email sender, wherein said search c ode also includes a combination of a country c ode number, an area code number and a local phone number;
(c) matching said search code with said phone codes stored in said information database to search for said respective phone code in said information database that matches identically with said search code so as to achieve said corresponding email address assigned with said respective phone code; and
(d) sending said email to said corresponding email address assigned with said respective phone code matched with said search code through the Internet.

2. The method, as recited in claim 1, wherein said search code is inputted through a wireless communication device which connects to the Internet via a wireless communication network, wherein said code location is displayed on a screen of said wireless communication device.

3. The method, as recited in claim 1, wherein said search code is inputted through a computer system connected to the Internet and said code location is displayed on a monitor of said computer system.

4. The method, as recited in claim 1, wherein said local phone number is a cellular phone number.

5. The method, as recited in claim 4, wherein no area code number is required to combine said search code and said respective search code when said cellular phone number has no area code.

6. A method of searching an email address of a POP (Post Office Protocol) type email system, comprising the steps of:
(a) providing an information database of at least a server connected through an Internet with a computer system of an email sender, wherein an email processing software and a search program are preloaded into said computer system which is connected to said server through the Internet, wherein said email processing software providing a code location, wherein a plurality of email addresses stored in said information database are respectively assigned with specific numerical phone codes each of which includes a sequential combination of a country code number, an area code number and a local phone number of a register of said respective email address;
(b) receiving a search request from an email sender by inputting a numerical search code in said code location of said email processing software of said computer system for an email to be sent by said email sender, wherein said search code also includes a combination of a country code number, an area code number and a local phone number;
(c) matching said search code with said phone codes stored in said information database to search for said respective phone code in said information database that matches identically with said search code so as to achieve said corresponding email address assigned with said respective phone code; and
(d) sending said email to said corresponding email address assigned with said respective phone code matched with said search code through the Internet.

7. The method, as recited in claim 6, wherein the step (d) further comprises the steps of:
(d-1) sending said email to a SMTP type email server of said email sender through the Internet;
(d-2) sending said email from said SMTP type email server to a POP type email server of said email address through the Internet; and
(d-3) downloading said email from said POP type email server to another computer system of said register of said email address assigned with said phone code that matches with said search code by said register of said email address.

8. The method, as recited in claim 6, wherein said search code is inputted through a wireless communication device which connects to the Internet via a wireless communication network, wherein said code location is displayed on a screen of said wireless communication device.

9. The method, as recited in claim 7, wherein said search code is inputted through a wireless communication device which connects to the Internet via a wireless communication network, wherein said code location is displayed on a screen of said wireless communication device.

10. The method, as recited in claim 6, wherein said search code is inputted through a computer system connected to the Internet and said code location is displayed on a monitor of said computer system.

11. The method, as recited in claim 7, wherein said search c ode is inputted through a computer system connected to the Internet and said code location is displayed on a monitor of said computer system.

12. The method, as recited in claim 6, wherein said local phone number is a cellular phone number.

13. The method, as recited in claim 12, wherein no area code number is required to combine said search code and said respective search code when said cellular phone number has no area code.

14. An email searching system, comprising:
email receiving devices of registers each of which is registered with an email address;
at least a website server including an information database connected to an Internet, a search program and a search request web page having a code location, wherein said email addresses are stored in said information database and each of said email address is assigned a specific numerical phone code which includes a sequential combination of a country code number, an area code number and a local phone number of said register of said respective email address; and
at least an email sending device through which said code location is displayed and an email sender is capable of sending a search request by inputting a numerical search code in said code location for an email to be sent from said email sending device, wherein said search code also includes a combination of a country code number, an area code number and a local phone number, wherein said search code is matched with said phone codes stored in said information database by means of said search program to search for said respective phone code in said information database that matches identically with said search code so as to send said email to said email receiving device of said corresponding email address assigned with said respective phone code.

15. The system, as recited in claim 14, wherein said email sending device is a wireless communication device which connects to the Internet via a wireless communication network, wherein said code location is displayed on a screen of said wireless communication device.

16. The system, as recited in claim 14, wherein each of said email sending device and said email receiving device is a wireless communication device which connects to the Internet via a wireless communication network, wherein said code location is displayed on a screen of said wireless communication.

17. The system, as recited in claim 14, wherein said local phone number is a cellular phone number.

18. The method, as recited in claim 17, wherein no area code number is required to combine said search code and said respective search code when said cellular phone number has no area code.

19. An email searching system, comprising:
email receiving devices of registers each of which is registered with an email address and connects to a POP type email server through an Internet;
at least a server including an information database connected to the Internet, wherein said email addresses are stored in said information database and each said email address is assigned a specific numerical phone code which includes a sequential combination of a country code number, an area code number and a local phone number of said register of said email address; and
at least an email sending device connected to a SMTP type email server through the Internet and preloaded with an email processing software and a search program, wherein said email processing software providing a code location, wherein an email sender inputs a search code in said email sending device by inputting a numerical search code in said code location for an email to be sent from said email sending device, wherein said search code also includes a combination of a country code number, an area code number and a local phone number, wherein said search code is matched with said phone codes stored in said information database by means of said search program to search for said respective phone code in said information database that matches identically with said search code so as to send said email to said SMTP type email server through the Internet, and then said email is sent from said SMTP type email server to said POP type email server of said email receiving device of said corresponding email address assigned with said respective phone code, wherein said email receiving device is able to download said email from said POP type email server.

20. The system, as recited in claim 19, wherein said email sending device is a wireless communication device which connects to the Internet via a wireless communication network, wherein said code location is displayed on a screen of said wireless communication device.

21. The system, as recited in claim 19, wherein each of said email sending device and said email receiving device is a wireless communication device which connects to the Internet via a wireless communication network, wherein said code location is displayed on a screen of said wireless communication.

22. The system, as recited in claim 19, wherein said local phone number is a cellular phone number.

23. The method, as recited in claim 22, wherein no area code number is required to combine said search code and said respective search code when said cellular phone number has no area code.
